(19) United States
(12) Patent Application Publication
(10) Pub. No.: US 2010/0148520 A1
(43) Pub. Date: Jun. 17, 2010

(54) Electrical energy amplifier system

(76) Inventor: Robert Michael Tyburski, Locust Grove, VA (US)

Correspondence Address: Robert Michael Tyburski, 8099 Meadowland Drive, Locust Grove, VA, 22508, US

(21) Appl. No.: 12/590,766

(22) Filed: Nov. 16, 2009

Related U.S. Application Data
(60) Provisional application No. 61/201,868, filed on Dec. 17, 2008.

(51) Int. Cl. H02K 7/18; H02K 53/00

(52) U.S. Cl. 290/1 R; 415/916

(57) ABSTRACT

This invention has been developed to source low cost, reliable, clean electrical power. Its compact size, portability and self-sufficient drive means and associated generator make it ideal for numerous different applications where electrical power is required. The invention utilizes a partially rotating disk, a magnet connected to the rotating disk that moves through a chamber of copper wires and per Faraday's Law of Induction generates voltage and current. The output is connected to electronic circuitry that conditions the generated signal for battery storage. The batteries DC voltage is connected to an inverter that converts the DC battery voltage to an 117 VAC, 60 cycle electrical energy.

### REFERENCE TO PRIOR APPLICATION

This application claims the benefit of provisional Application No. 61/201,868, filed Dec. 17, 2008 entitled Electrical Energy Amplifier System.

### BACKGROUND OF THE INVENTION

Various portable electrical energy systems are in use and are known in this field of Patented Art. This invention describes a portable self-sufficient portable electrical energy system based on unique drive means, a generator and electrical storage means. This combination of components produces electrical energy every minute each day without any precondition of its location, without utilizing any external form of energy source such as gasoline, coal, wood, solar wind, steam and Nuclear, thereby eliminating the negative effects of pollution in the atmosphere. Also fossil fuels motors are generally very noisy, solar devices require direct sunlight, Nuclear reactors require lead enclosures and highly trained personnel to handle a potentially dangerous device and wind devices require wind. All known existing portable electrical energy systems have a negative operational condition relative to the invention being proposed in this patent application.

### BRIEF DESCRIPTION OF THE DRAWINGS

The above and other objects, advantages and features of the invention will become more apparent when considered with the following specification and accompanying drawings wherein:

FIG. 1 shows the front view of the plastic drive disk and generator coil means and associated components.

FIG. 2 shows a section view of the generator coil and the rare earth magnet.

FIG. 3 shows a wire wrapped plastic rod with its wire terminations.

FIG. 4 shows a solenoid and the latch bracket attached to the plastic drive disk.

FIG. 5 shows the block diagram of the storage batteries and associated electronics assemblies.

### DETAILED DESCRIPTION OF THE INVENTION

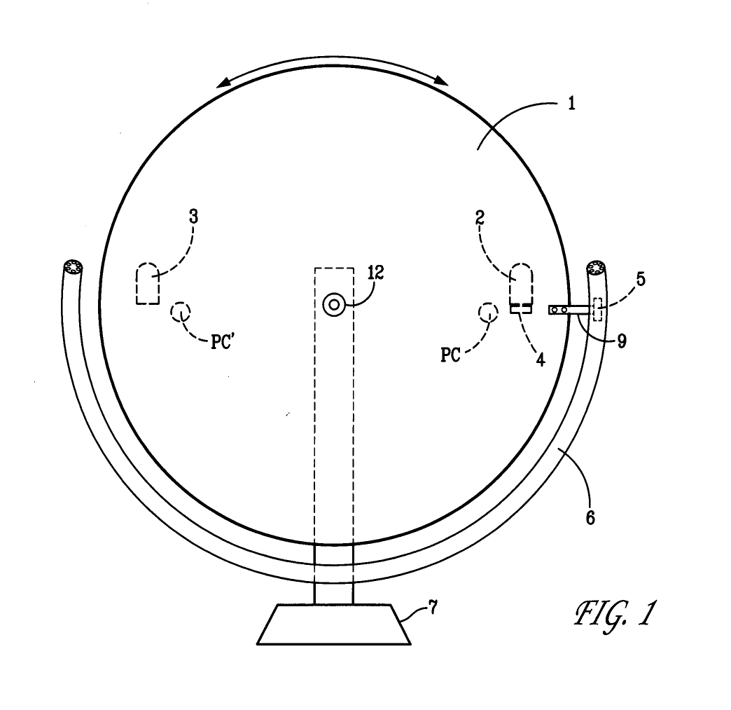

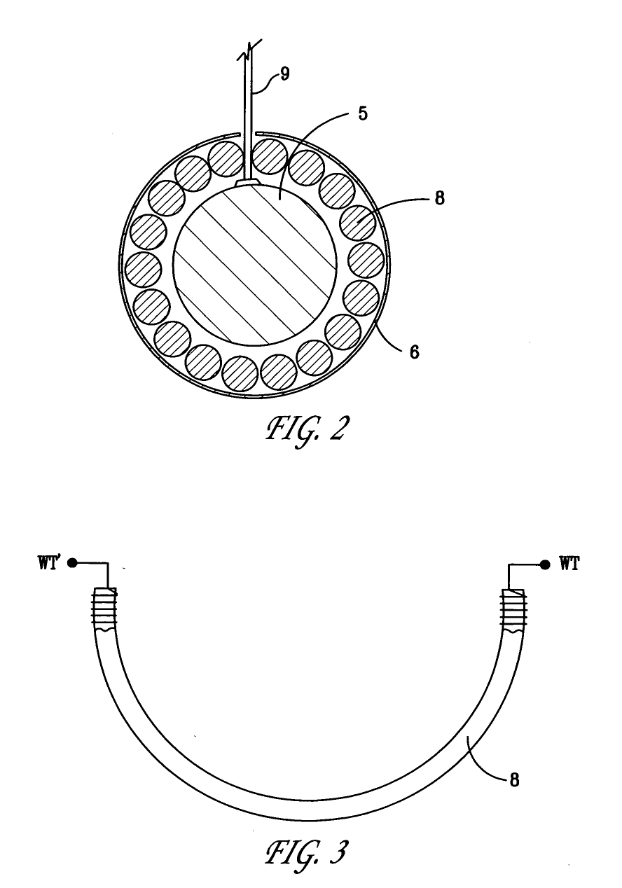

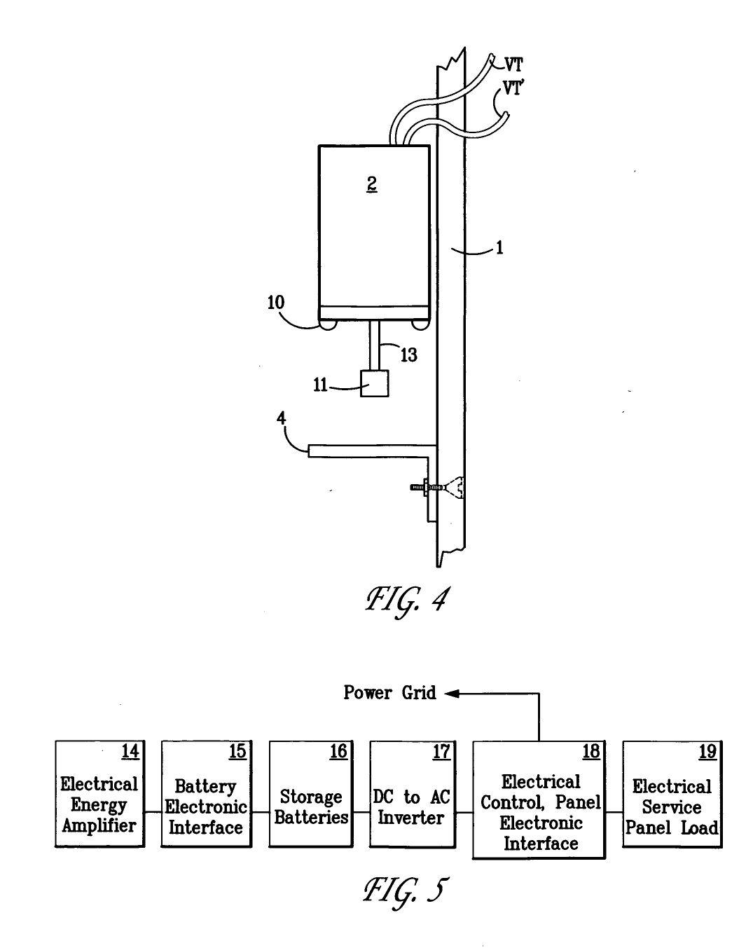

Referring to FIG. 1, an oscillating dick assembly comprising of a thin plastic disk 1, solenoid 2 and 3, photocells PC and PC′, latch bracket 4, rare earth magnet 5, molded plastic coil assembly 6, stand support 7, magnet connecting arm 9, low friction bearing assembly 12. Referring to FIG. 2, this is a section view of the molded coil assembly. It consists of the rare earth magnet 5, a molded plastic coil assembly 6 and wire wrapped plastic rods 8 and magnet connecting arm 9. Referring to FIG. 3, this is one wire wrapped plastic rod 8 with wire terminals WT and WT′. Referring to FIG. 4, this is a detailed drawing of the component parts relating to the solenoid assemble. It comprises of a DC operated solenoid 2, attached rubber shock absorbers 10, solenoid plunger 13, solenoid plunger tip magnet 11, latch bracket 4 that is attached to the oscillating plastic disk 1. Referring to FIG. 5, is the Electrical Energy Amplifier 14, Battery Electronic Interface 15, Storage Batteries 16, DC to AC Inverter 17, Electrical Control Panel Electronic Interface 18, and Electronic Service Panel Load 19. The operation of this invention is based on two well known physical laws, 1) Newton's Laws of Motion, 2) Faraday's Law of Induction. In order to generate electrical energy two major components are required for this invention, 1) Motor means, 2) Generator means. The theory of operation of the motor means is as follows. This motor means causes no pollution and operates silently. FIG. 1 shows a plastic disk 1, 18 inches in diameter (could be larger or smaller) attached to a low friction bearing assembly 12 that is also attached to the stand support 7. Gravity, Inertia and the unbalanced condition of the plastic disk 1 due to the weight of the connected magnetic connecting arm 9 and the rare earth magnetic 5 provide continual movement of the plastic disk 1 through an arc of almost 180-degrees when released from the three o'clock position. Because the supporting bearing assembly has a finite amount of friction the plastic disk 1 will not complete a full 180-degree rotation but something less (approximately 176 degrees). Solenoids 2 and 3, latch bracket 4 and photocells PC and PC′ were added to achieve a full 180-degree rotating arc each time the plastic disk 1 travelled from one side to the other in perpetuity utilizing a minimal amount of electrical energy. The solenoid plunger 13 of solenoid 2 is positioned down approximately three quarters of an inch and a solenoid plunger tip magnet 11 will make contact with the latch bracket 4 that is attached to the plastic disk 1. Simultaneously the photocell PC will be activated resulting in pulling up the plastic disk 1 to the 180-degree position (nine o'clock). Two rubber shock absorber 10, one eigth of an inch longer than the other will effectively peel the latch bracket from the solenoid plunger tip magnet 11 and due to the mechanical energy stored in the rubber shock absorbers 10, gravity and the unbalanced condition of the plastic disk 1, it will rotate in the opposite direction. The cycle will repeat itself when the latch bracket 4 is rotated and makes contact with solenoid assembly 3. It can be seen that the oscillating plastic disk 1 has met the requirements of a motor means. The theory of operation of the generator means follows. FIG. 3 shows the coil assembly enclosure 6 consisting of 18 each wire wrapped plastic rods 8. These 18 rods (could be more or less) are wrapped with sufficient amount of coated copper wire and electrically connected together to take full advantage of the electromagnetic force (EMF) developed by the moving rare earth magnet 5 connected to the plastic disk 1 via the magnetic connecting arm 9. The movement of the rare earth magnet 5 in the center of these wire wrapped rods 8 mounted within the molded plastic coil assembly 6 will generate an EMF voltage in accordance to Faraday's Law of Induction. The molded plastic coil assembly 6 is formed on a semi-circle to match very closely the overall profile of the movement of the rare earth magnet 5 attached to the plastic disk 1 for the full 180-degree of travel. The theory of operation of the associated electronics and storage components follows. FIG. 5 shows a system block diagram of the associated electronics and storage components. The electrical energy amplifier 14 acts as an interface impedance module between the output of the molded plastic coil assembly 6 of 18 wire wrapped plastic rods terminals WT and WT′ each individually electrically connected together to form an input signal. This modules output analog signal is connected to the battery electronic interface 15. This module converts the analog signal from the electrical energy amplifier 14 to a DC voltage to charge storage batteries 16. The output of storage batteries 16 which consist of several Deep Cycle batteries are connected to an DC to AC inverter 17 module that converts the 12 VDC battery voltage into 117 VAC, 60 cycle electrical energy. One of numerous applications for this portable self-contained electrical generation system is to supply 117 VAC to all the lower wattage apparatus found in a typical home globally. However, those knowledgeable in the engineering field can foresee that modifications to some of the components would also allow for high wattage applications. The electrical control panel electronic interface 18 selects either power from the power grid for the higher wattage devices or power from the DC to AC inverter 17 for the lower wattage devices. The proper connections between the electrical service panel load 19 circuit breakers and the electrical control panel electronic interface 18 would be required. It should be noted that in some household applications it may be beneficial to use short term power from the power grid to charge the batteries. The technology exists whereas it is possible in some states for the homeowner to sell his/her extra electrical power to Utility Companies for profit. As an example, extra power would be available when the homeowner is on an extended vacation.

While the invention has been described in relation to preferred embodiments of the invention, it will be appreciated that other embodiments, adaptations and modifications of the invention will be apparent to those skilled in the art.

What is claimed is:

1. A portable self-contained electrical generation system for providing electrical voltage and current for use by electrically operated apparatus, said system requires no external energy source of any form for its operation.

2. The portable self-contained electrical generation system defined in claim 1 wherein the drive means oscillates utilizing no external energy of any form that is noise and pollution free.

3. The portable self-contained electrical generation system defined in claim 1 wherein the generator means consists of several lengths of insulating rods that have been wrapped with wire and electrically connected together.

4. The portable self-contained electrical generation system defined in claim 1 wherein the wire wrapped insulating rods has been assembled so as to allow for a magnet to traverse through the center of said wire wrapped rods.

5. The portable self-contained electrical generation system defined in claim 1 wherein said systems can be stacked in parallel to increase the voltage and current output capacity.
